(19) United States
(12) Patent Application Publication
(10) Pub. No.: US 2014/0201220 A1
(43) Pub. Date: Jul. 17, 2014

(54) COMMUNICATION VIA JOINING THE CONVERSATION

(71) Applicant: ELWHA LLC, Bellevue, WA (US)

(72) Inventors: Edward K.Y. Jung, Bellevue, WA (US); Royce A. Levien, Lexington, MA (US); Mark A. Malamud, Seattle, WA (US)

(73) Assignee: Elwha LLC, Bellevue, WA (US)

(21) Appl. No.: 13/744,370

(22) Filed: Jan. 17, 2013

(51) Int. Cl. G06F 17/30

(52) U.S. Cl. CPC G06F 17/30595
USPC 707/752; 707/736

(57) ABSTRACT

A method substantially as shown and described the detailed description and/or drawings and/or elsewhere herein. A device substantially as shown and described the detailed description and/or drawings and/or elsewhere herein.

### BRIEF DESCRIPTION OF THE FIGURES

No drawings are included.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

The following pages outline one or more implementations of systems and methods for performing communications. The following will be understood by one of skill to be exemplary.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. (canceled)

2. (canceled)

3. A system comprising:
a machine configured to create a physical reality of at least one of creating or maintaining a demonstrable skill versus a certified dynamic-reputation database;
a machine configured to create a physical reality of receiving an enquiry related to at least one demonstrable skill; and
a machine configured to create a physical reality of transmitting at least one descriptor of a certified dynamic-reputation database.

4. The system of claim 3 wherein at least one machine configured to create a physical reality further comprises:
at least one of static or sequenced hardware elements.

5. The system of claim 3, wherein at least one machine configured to create a physical reality further comprises:
at least one ordered matter element.

6. The system of claim 5, wherein the at least one ordered matter element further comprises:
at least one logic gate.

7. The system of claim 6, wherein the at least one logic gate further comprises:
at least one physical device that may be driven to change physical state in order to create a physical reality of Boolean logic.

8. The system of claim 5, wherein the at least one ordered matter element further comprises:
at least one logic circuit.

9. The system of claim 8, wherein the at least one logic circuit further comprises:
one or more physical logic gates that may be arranged to form physical logic circuits that may be driven to create a physical reality of one or more logical functions.

10. The system of claim 9, wherein one or more physical logic gates that may be arranged to form physical logic circuits that may be driven to create a physical reality of one or more logical functions further comprises:
at least one of a multiplexer, a latch, or a register.

11. The system of claim 9, wherein one or more physical logic gates that may be arranged to form physical logic circuits that may be driven to create a physical reality of one or more logical functions further comprises:
at least one of an arithmetic logic unit, a computer memory, or a bridge.

12. The system of claim 9, wherein one or more physical logic gates that may be arranged to form physical logic circuits that may be driven to create a physical reality of one or more logical functions further comprises:
at least one central processing unit.

13. The system of claim 9, wherein one or more physical logic gates that may be arranged to form physical logic circuits that may be driven to create a physical reality of one or more logical functions further comprises:
at least one configuration responsive to a defined Instruction Set Architecture.

14. The system of claim 9, wherein one or more physical logic gates that may be arranged to form physical logic circuits that may be driven to create a physical reality of one or more logical functions further comprises:
at least one circuit constructed to convert a machine language instruction to at least one of a voltage control, a timing control, a selection control, or an activation control.

15. The system of claim 5, wherein at least one ordered matter element further comprises:
at least one integrated electrical circuit.

16. The system of claim 5, wherein at least one ordered matter element further comprises:
at least one application specific integrated electrical circuit.

17. The system of claim 5, wherein at least one ordered matter element further comprises:
at least one general purpose computer configured by a computer program.

18. The system of claim 17, wherein at least one general purpose computer configured by a computer program further comprises:
at least one general purpose computer processor operably coupled with a hardware memory having at least a part of the computer program.

19. The system of claim 3, wherein a machine configured to create a physical reality of at least one of creating or maintaining a demonstrable skill versus a certified dynamic-reputation database further comprises:
a machine configured to create a physical reality of accepting at least one certification entity in association with at least one demonstrable skill.

20. The system of claim 19, wherein a machine configured to create a physical reality of accepting at least one certification entity in association with at least one demonstrable skill comprises:
a machine configured to create a physical reality of accepting an identification of at least one publicly-owned entity or at least one privately-owned entity in association with the at least one demonstrable skill.

21. The system of claim 20, wherein a machine configured to create a physical reality of accepting an identification of at least one publicly-owned entity or at least one privately-owned entity in association with the at least one demonstrable skill comprises:
a machine configured to create a physical reality of associating at least one computation/communication device with at least one publicly-owned entity or at least one privately-owned entity.

22. The system of claim 21, wherein a machine configured to create a physical reality of associating at least one computation/communication device with at least one publicly-owned entity or at least one privately-owned entity comprises:
a machine configured to create a physical reality of associating at least one electronic signature with at least one publicly-owned entity or at least one privately-owned entity, where the at least one electronic signature includes but is not limited to at least one of:
a network identifier;
a machine component identifier; or
at least one computer controlled machine configuration.

23. The system of claim 3, wherein a machine configured to create a physical reality of receiving an enquiry related to at least one demonstrable skill comprises:
a machine configured to create a physical reality of receiving a domain-specific problem statement.

24. The system of claim 23, wherein a machine configured to create a physical reality of receiving a domain-specific problem statement comprises:
a machine configured to create a physical reality of generating a domain-specific dialog associated with a domain-specific problem statement.

25. The system of claim 24, wherein a machine configured to create a physical reality of generating a domain-specific dialog associated with a domain-specific problem statement comprises:
a machine configured to create a physical reality of recognizing at least one of an identity of a querier, a past question posed by a querier, an entity with whom a querier has worked, or problems solved by a querier; and
a machine configured to create a physical reality of recalling an interactive script associated with least one of an identity of a querier, a past question posed by a querier, an entity with whom a querier has worked, or problems solved by a querier.

26. The system of claim 24, wherein a machine configured to create a physical reality of generating a domain-specific dialog associated with a domain-specific problem statement comprises:
a machine configured to create a physical reality of recognizing at least one problem domain; and
a machine configured to create a physical reality of recalling an interactive script associated with at least one problem domain.

27. The system of claim 3, wherein a machine configured to create a physical reality of transmitting at least one descriptor of a certified dynamic-reputation database comprises:
a machine configured to create a physical reality of transmitting at least one indicator of an encapsulation of at least one skill.

28. The system of claim 27, wherein a machine configured to create a physical reality of transmitting at least one indicator of an encapsulation of at least one skill comprises:
a machine configured to create a physical reality of transmitting a representation by at least one certification entity that an individual and/or a firm has a certified defined set of skills, wherein the certified defined set of skills is based at least in part upon at least one past performance in a real or virtual environment.

29. The system of claim 27, wherein a machine configured to create a physical reality of transmitting at least one indicator of an encapsulation of at least one skill comprises:
a machine configured to create a physical reality of transmitting a representation by at least one certification entity that an individual and/or a firm has a certified defined set of skills, wherein the certified defined set of skills is based at least in part upon an extrapolation of at least one past performance in a real or virtual environment.

30. The system of claim 27, wherein a machine configured to create a physical reality of transmitting at least one indicator of an encapsulation of at least one skill comprises:
a machine configured to create a physical reality of transmitting a representation by at least one certification entity that an individual and/or a firm has a certified defined set of skills, wherein the certified defined set of skills is based at least in part upon at least one relationship based upon a social network in a real or virtual environment.

31. The system of claim 27, wherein a machine configured to create a physical reality of transmitting at least one indicator of an encapsulation of at least one skill comprises:
a machine configured to create a physical reality of consulting a log of one or more device interactions associated with an individual and/or a firm; and
a machine configured to create a physical reality of transmitting at least one indicator of an encapsulation of at least one skill in a queued fashion responsive to the log of one or more device interactions associated with an individual and/or a firm.

32. A method comprising:
at least one of creating or maintaining a demonstrable skill versus a certified dynamic-reputation database;
receiving an enquiry related to at least one demonstrable skill; and
transmitting at least one descriptor of a certified dynamic-reputation database.

33. A system comprising:
means for at least one of creating or maintaining a demonstrable skill versus a certified dynamic-reputation database;
means for receiving an enquiry related to at least one demonstrable skill; and
means for transmitting at least one descriptor of a certified dynamic-reputation database.
